(19) United States
(12) Patent Application Publication
(10) Pub. No.: US 2026/0172964 A1
(43) Pub. Date: Jun. 18, 2026

(54) ELECTRIC EQUIPMENT

(71) Applicant: CANON KABUSHIKI KAISHA, Tokyo (JP)

(72) Inventor: TAKUMI SUZUKI, Kanagawa (JP)

(21) Appl. No.: 19/419,364

(22) Filed: Dec. 15, 2025

(30) Foreign Application Priority Data
Dec. 17, 2024 (JP) 2024-220997

(51) Int. Cl. H04W 52/02; H02M 1/00

(52) U.S. Cl. CPC H04W 52/0229; H02M 1/0032

(57) ABSTRACT

An electric equipment includes a first control unit configured to control the electric equipment, a second control unit configured to control a power mode of the first control unit, and at least one detection unit configured to detect a state of the electric equipment. The power mode of the first control unit includes a first power mode and a second power mode lower in power consumption than the first power mode. The second control unit is configured to monitor a detection result of the detection unit in the first power mode and the second power mode, and provide a notification to the first control unit in a case where the detection result of the detection unit changes.

### BACKGROUND

### Field of the Technology

The present disclosure relates to a power control technique for electric equipment.

### Description of the Related Art

For power consumption reduction, there is known electric equipment that shifts a power mode to a power saving mode in a case where a predetermined condition is satisfied, and returns to a normal power mode in a case where a return cause is established. There is a known technique for detecting a state change of electric equipment even in a power saving mode. For example, Japanese Patent Laid-Open No. 2018-22091 discloses an apparatus including a sensor that needs detection only in the power saving mode, a sensor that needs detection in both the power saving mode and the normal mode, a power source that operates constantly, and a power source that operates only in the normal mode.

In a case where the detection result of the sensor is monitored in the power saving mode, a monitoring circuit different from a control circuit that is in a stopped state in the power saving mode is required. In a case where the control circuit is to acquire the detection result of the sensor in the normal mode, communication between the control circuit and the monitoring circuit may be complicated, or the circuit configuration between these circuits may be complicated.

### SUMMARY

The present disclosure provides a technique that can detect a state of electric equipment with a relatively simple configuration and processing in each power mode.

According to an aspect of the present disclosure, there is provided an electric equipment comprising: a first control unit configured to control the electric equipment; a second control unit configured to control a power mode of the first control unit; and at least one detection unit configured to detect a state of the electric equipment, wherein the power mode of the first control unit includes a first power mode and a second power mode lower in power consumption than the first power mode, and the second control unit is configured to monitor a detection result of the detection unit in the first power mode and the second power mode, and provide a notification to the first control unit in a case where the detection result of the detection unit changes.

Features of the present disclosure will become apparent from the following description of embodiments with reference to the attached drawings. The following description of embodiments is given by way of example.

### BRIEF DESCRIPTION OF THE DRAWINGS

FIG. 1 is an external view of electric equipment according to one embodiment of the present disclosure.

FIG. 2 is an explanatory view illustrating an internal mechanism of the electric equipment of FIG. 1.

FIG. 3 is a block diagram of a control unit of the electric equipment of FIG. 1.

FIG. 4 is a block diagram of a motor control circuit.

FIGS. 5A and 5B are flowcharts showing control examples.

FIG. 6 is a flowchart showing a control example.

FIG. 7 is a flowchart showing a control example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Outline of Electric Equipment

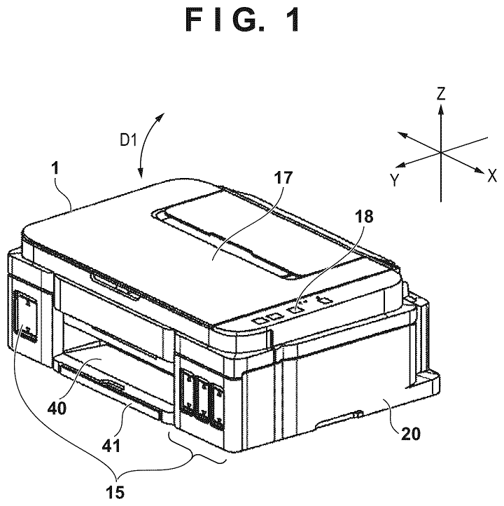

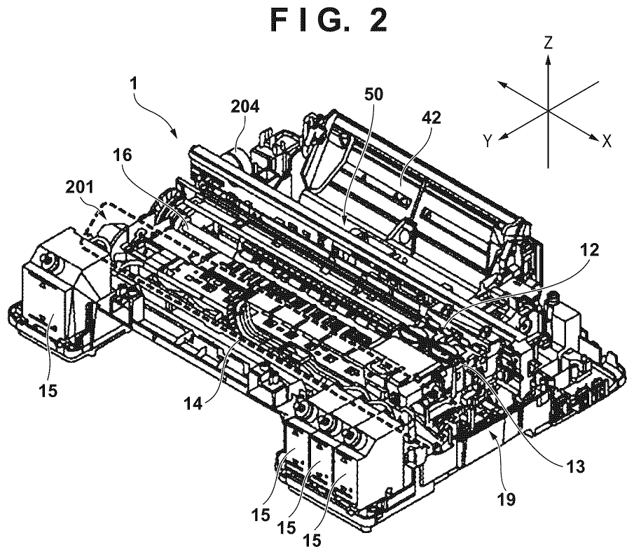

FIG. 1 is an external view of electric equipment 1 according to one embodiment of the present disclosure as viewed from a front side, and FIG. 2 is an explanatory view illustrating an internal mechanism of the electric equipment 1. The electric equipment 1 of the present embodiment is an inkjet printing apparatus that discharges ink as liquid to perform printing on a print medium, but the present disclosure is also applicable to various types of electric equipment other than the inkjet printing apparatus. In the drawing, arrows X and Y indicate horizontal directions orthogonal to each other, and an arrow Z indicates a top-bottom direction (gravity direction). The X direction is a width direction (left-right direction) of the electric equipment 1. The Y direction is a depth direction of the electric equipment 1.

Note that “printing” includes not only a case of forming significant information such as a character and a figure but also a case of widely forming an image, a motif, a pattern, or the like on a print medium or a case of performing processing a medium regardless of significance, and it does not matter whether or not the printing is manifested so as to be visually perceivable by a human. The present embodiment assumes sheet-like paper as “print medium”, but may be cloth, plastic film, or the like.

The electric equipment 1 includes a main body unit 20, a scanner unit 17 that performs a document reading operation, and an operation unit 18 that enables a user to perform an operation such as command input. The scanner unit 17 is an opening/closing unit that is disposed above the main body unit 20 and is openable/closable in an arrow D1 direction with respect to the main body unit 20. The scanner unit 17 functions also as a cover member that covers the inside of the main body unit 20, and the user can access the inside of the main body unit 20 by opening the scanner unit 17. The operation unit 18 includes, for example, a power supply key. The user can issue a power on instruction and a power off instruction to the electric equipment 1 by an operation on the power supply key. By the operation on the power supply key, the state of the electric equipment 1 transitions to a power on state (soft on state) and a power off state (soft off state).

A front portion of the main body unit 20 is provided with a plurality of ink tanks 15 that store inks. Each of the ink tanks 15 stores ink of different types. For example, inks of different colors are stored. By opening the scanner unit 17, it is possible to perform work to replenish ink in the ink tank 15.

The main body unit 20 is provided with a printing mechanism. The main body unit 20 includes a feeding unit 50 that feeds a print medium, a conveyance roller 16 that conveys the print medium, and an ejection unit 40 that ejects the print medium. The conveyance roller 16 is driven by a conveyance motor 201 via a gear.

The feeding unit 50 feeds a print medium stacked on a paper feed cassette 41 and a print medium stacked on a rear tray 42, which is foldable. A fed print medium is conveyed by the conveyance roller 16. A printhead 13 discharges, onto the print medium, ink supplied from the ink tank 15. The printhead 13 includes a discharge surface on which a plurality of nozzles for discharging ink are formed. Each of the nozzles is provided with an electrothermal conversion element (heater), for example, and the electrothermal conversion element is heated by energization to cause the ink to bubble, and the ink is discharged with the bubbling energy. The print medium on which printing has been completed is ejected from the ejection unit 40 to the outside of the electric equipment 1.

The printhead 13 is mounted on a carriage 12. The carriage 12 moves in a main scanning direction (X direction) intersecting a conveyance direction (Y direction) of the print medium by a driving mechanism using a carriage motor 204 as a driving source. The driving mechanism is a belt transmission mechanism in the present embodiment. In the present embodiment, the conveyance direction and the main scanning direction are orthogonal to each other. The printhead 13 mounted on the carriage 12 discharges ink droplets while moving in the main scanning direction, and performs a printing operation of printing an image for one band on a print medium. When an image for one band is printed on the print medium, the print medium is conveyed in the conveyance direction by a predetermined amount by the conveyance roller 16 (intermittent conveyance operation). By repeating the printing operation for one band and the intermittent conveyance operation, the image is printed on the entire print medium.

In this manner, the electric equipment 1 of the present embodiment is a serial type inkjet printing apparatus in which the printhead 13 is mounted on the carriage 12 that reciprocates. However, the present disclosure is applicable also to other printing apparatuses such as an inkjet printing apparatus including what is called a full line head printhead in which a region corresponding to the width of the print medium is provided with a plurality of nozzles for discharging liquid.

One end of a movement range of the carriage 12 is provided with a maintenance unit 19. The maintenance unit 19 maintains and recovers a liquid discharge performance of the printhead 13. In the printhead 13, nozzles may be clogged in a case where a period during which ink is not discharged is long. It is necessary to periodically perform a recovery operation against such performance deterioration of the printhead 13. The maintenance unit 19 includes, for example, a capping member that caps the discharge surface of the printhead 13, a pump that sucks liquid from the printhead 13 via the capping member, and the like. Capping can prevent drying of the nozzle. Suction by the pump can eject the ink having increased viscosity from the nozzle.

### Control Unit

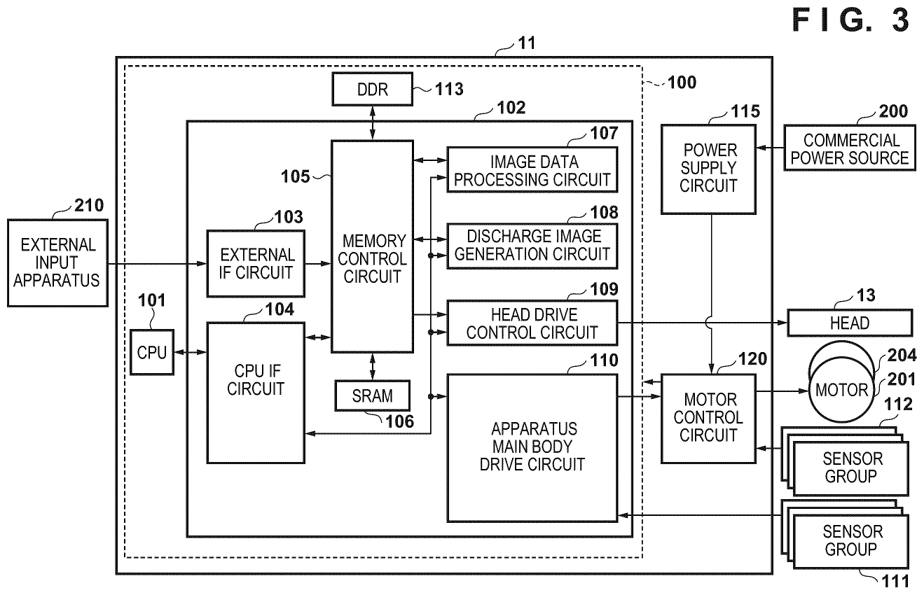

FIG. 3 is a block diagram of a control unit 11 included in the electric equipment 1. The control unit 11 is an electric circuit that controls the electric equipment 1, and an external input apparatus 210 is an apparatus that provides print data to the electric equipment 1, and is, for example, a personal computer (PC), a smartphone, a storage device, or the like. The control unit 11 includes a main control circuit 100, a power supply circuit 115, and a motor control circuit 120.

The main control circuit 100 includes a CPU 101, an ASIC 102, and a storage device (DDR) 113. The CPU 101 is a processor that controls the entire electric equipment 1, and the ASIC 102 is an integrated circuit that performs hardware control specific to the electric equipment 1. The ASIC 102 includes an external interface circuit 103, a CPU interface circuit 104, a memory control circuit 105, an SRAM 106, an image data processing circuit 107, a discharge image generation circuit 108, a head drive control circuit 109, and an apparatus main body drive circuit 110.

Data is input to the external interface circuit 103 from the external input apparatus 210. The external interface circuit 103 includes an interface circuit connected to the external input apparatus 210, such as a USB interface circuit, a wireless communication interface circuit, a LAN interface circuit, and an IDE interface circuit. The CPU interface circuit 104 is connected to the CPU 101 to control communication of each block in the ASIC 102 from the CPU 101.

The memory control circuit 105 is connected to an external IF circuit 103, the SRAM 106, the image data processing circuit 107, the discharge image generation circuit 108, the head drive control circuit 109, and a DDR 113. The memory control circuit 105 transfers, to the SRAM 106, image data input from the external input apparatus 210, and also performs reading and writing control of data to the SRAM 106 and the DDR 113. The SRAM 106 is a work buffer, and stores image data divided into specific sizes. This SRAM 106 may be included in a number corresponding to the number of colors of ink to be discharged or the number of nozzles.

The image data processing circuit 107 performs image processing on the image data stored in the SRAM 106. The image processing mentioned here is processing such as boundary processing, edge processing, HV conversion, smoothing, and non-discharge interpolation, but is not limited to this.

The discharge image generation circuit 108 converts image data after image processing is ended into data (hereinafter, called discharge image data) in a format suitable for the nozzle of the printhead 13. The head drive control circuit 109 transfers the discharge image data to the printhead 13, and drives the printhead 13 to cause a discharge operation to be performed.

The DDR 113 is a reception buffer externally attached to the ASIC 102. The DDR 113 stores image data subjected to image correction processing. The apparatus main body drive circuit 110 generates and transfers a control signal and a power control signal for driving the conveyance motor 201 and the carriage motor 204. The apparatus main body drive circuit 110 acquires each detection result of a sensor group 111.

The power supply circuit 115 generates a DC power source from a commercial power source 200, and supplies power to each unit of the electric equipment 1. In the present embodiment, the power supply circuit 115 generates a DC power source from the commercial power source 200, but may be configured to generate a power source from an AC adapter, a battery pack, or the like.

The motor control circuit 120 controls the conveyance motor 201 and the carriage motor 204 based on the control data transferred from the apparatus main body drive circuit 110. In the present embodiment, the number of control target motors is two, but may be three or more.

In the case of the present embodiment, the motor control circuit 120 functions as a power control circuit that switches the power mode of the main control circuit 100 in addition to the drive control of the conveyance motor 201 and the carriage motor 204. Use of the motor control circuit 120 also as a power control circuit can reduce the number of circuit components. Note that the motor control circuit 120 may be a control circuit that controls an actuator other than the motor.

In the case of the present embodiment, the power mode of the main control circuit 100 includes two types, a normal mode and a power saving mode. However, the power mode may include three types or more. In the power saving mode, power consumption of the main control circuit 100 is smaller than that in the normal mode. In the case of the present embodiment, power supply to the main control circuit 100 is interrupted in the power saving mode.

Sensor groups 111 and 112 are a generic term for sensors included in the electric equipment 1, and these are sensors having different detection targets. The detection target of the sensor group 111 needs to be monitored in the normal mode, but does not need to be monitored in the power saving mode. The detection target of the sensor group 112 needs to be monitored in both the normal mode and the power saving mode. The sensor group 112 is connected to the motor control circuit 120, and the sensor group 112 and the motor control circuit 120 are supplied with power also in the power saving mode.

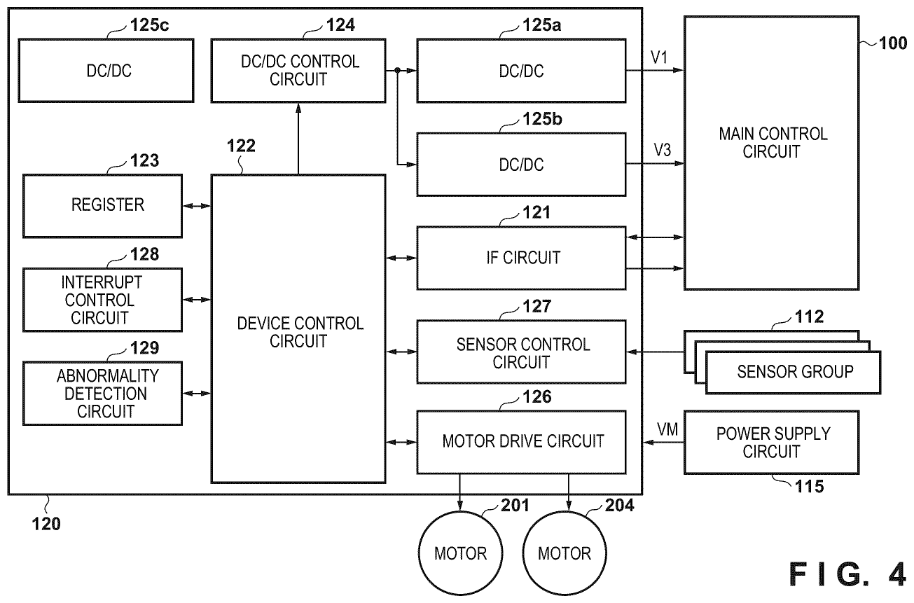

FIG. 4 is a block diagram of the motor control circuit 120. The motor control circuit 120 includes an interface (IF) circuit 121, a device control circuit 122, a register group 123, a DC/DC control circuit 124, DC/DCs 125a to 125c, and a sensor control circuit 127. The motor control circuit 120 further includes an interrupt control circuit 128, an abnormality detection circuit 129, and a motor drive circuit 126.

The interface circuit 121 is connected to the ASIC 102. The interface circuit 121 controls communication of control data between the apparatus main body drive circuit 110 of the ASIC 102 and the device control circuit 122, and also controls an interrupt request to the ASIC 102.

The device control circuit 122 is connected to the interface circuit 121, the register 123, the DC/DC control circuit 124, the sensor control circuit 127, the interrupt control circuit 128, the abnormality detection circuit 129, and the motor drive circuit 126. The device control circuit 122 analyzes control data transferred from the main control circuit 100 via the interface circuit 121, and controls each circuit in the motor control circuit 120.

The register 123 stores various types of information. For example, information such as a motor control state, a power control state, an internal frequency of the motor control circuit 120, a state of the sensor group 112, and an abnormal state is stored.

The DC/DC control circuit 124 controls on/off of the DC/DCs 125a and 125b, timings of on/off, a generated voltage, a switching frequency, and on/off of frequency diffusion (SSCG). The DC/DCs 125a and 125b generate a power source voltage to be supplied to each unit of the printing apparatus 1 from a voltage VM supplied from the power supply circuit. For example, the DC/DC 125a generates a power source voltage V1 of 1.1 V for an internal logic, and the DC/DC 125b generates a power source voltage V3 of 3.3 V for an external port. These power source voltages V1 and V3 are supplied to the main control circuit 100 in the normal mode, and are interrupted in the power saving mode. The DC/DC 125c generates a power source voltage used in the motor control circuit 120 from the voltage VM supplied from the power supply circuit regardless of the power mode of the main control circuit 100. Note that the configuration of DC/DC presented here is an example, and the type of voltage generated by DC/DC and the number of DC/DC are not necessarily limited to this.

The sensor group 112 is connected to the sensor control circuit 127. The sensor group 112 includes a sensor that detects a state of the electric equipment 1 in the power saving mode. Examples of such a sensor include a cassette sensor, a rear paper feed sensor, and a cover sensor in the case of the present embodiment. The cassette sensor detects attachment/detachment of the paper feed cassette 41. In a case where attachment/detachment is detected by the cassette sensor, there is a possibility that the type of the print medium has been replaced. The rear paper feed sensor detects stack of the print medium on the rear tray 42. In a case where the detection result of the rear paper feed sensor changes, there is a possibility that the print medium runs out or the type of the print medium is replaced. The cover sensor detects opening/closing of the scanner unit 17. In a case where the scanner unit 17 is opened, there is a possibility that the ink tank 15 has been replenished with ink.

In a case where the detection result of the sensor of the sensor group 112 changes, it is recorded that a state change has occurred in the register 123. Methods for recording a state change include a method of writing 1 bit into the register 123 in a case where the output change of the sensor is any of from High to Low and from Low to High or the both occur. There is also a method of having a total of 2 bits, i.e., 1 bit for each of the changes from High to Low and from Low to High.

The sensor control circuit 127 can control which sensor in the sensor group 112 to monitor in accordance with the operation mode of the electric equipment 1 in the normal mode. The operation mode includes, for example, a printing operation mode for performing printing on a print medium and a recovery operation mode for recovering discharge performance of the printhead 13 by the maintenance unit 19. During the recovery operation mode, even if the detection result of the cassette sensor or the rear paper feed sensor changes, the corresponding processing is not performed. When the recovery operation mode is set, monitoring of these sensors is disabled by the sensor control circuit 127, whereby a processing load can be reduced.

The interrupt control circuit 128 is a circuit that controls whether or not to provide a notification that serves as an interrupt request to the main control circuit 100 in accordance with the detection result of the sensor group 112. In the sensor control circuit 127, when a valid sensor in accordance with the operation mode is determined and a change in the detection result of the valid sensor occurs, an interrupt signal is output from the interrupt control circuit 128 to the device control circuit 122. The device control circuit transmits an interrupt request to the main control circuit 100 via the interface circuit 121. When the interrupt request is generated, interrupt information indicating that the interrupt request is generated is recorded in the register 123. When an interrupt clear command is received from the main control circuit 100, the interrupt information of the register 123 is cleared, the interrupt request is also cleared, and generation of the next interrupt request is enabled. The interrupt signal from the interrupt control circuit 128 to the device control circuit 122 can be output as a pulse or can be output at a level of High or Low.

The abnormality detection circuit 129 detects abnormalities such as overcurrent, overvoltage, low voltage, and chip temperature. Detected abnormalities above are notified to the main control circuit 100. The motor drive circuit 126 includes a circuit that drives two motors of the motors 201 and 204. Note that the motor may be a DC motor or a stepping motor.

### Power Control

Next, power control using the motor control circuit 120, specifically, control in the normal mode and the power saving mode will be described. When the power supply circuit 115 is connected to the commercial power source 200, the power supply circuit 115 generates the DC power source voltage VM. When the voltage VM is applied to the motor control circuit 120, first, the power source voltage V1 is generated from the DC/DC 125a, and next the power source voltage V3 is generated from the DC/DC 125b. This makes the main control circuit 100 ready to be activated. When the main control circuit 100 is activated, the peripheral circuit is brought into an operable state in accordance with the state of the electric equipment 1. This is the normal mode.

In the power saving mode, the generation of the power source voltages V1 and V3 of the DC/DCs 125a and 125b is stopped. In a case of shifting from the normal mode to the power saving mode, a power mode switching instruction is issued from the main control circuit 100 to the motor control circuit 120, and the device control circuit 122 controls the DC/DC control circuit 124. By this, the generation of the power source voltages V1 and V3 of the DC/DCs 125a and 125b is stopped. By this, the mode shifts to the power saving mode. Also in the power saving mode, the device control circuit 122 is supplied with power, and monitoring of the sensor group 112 is possible.

### Example of Processing

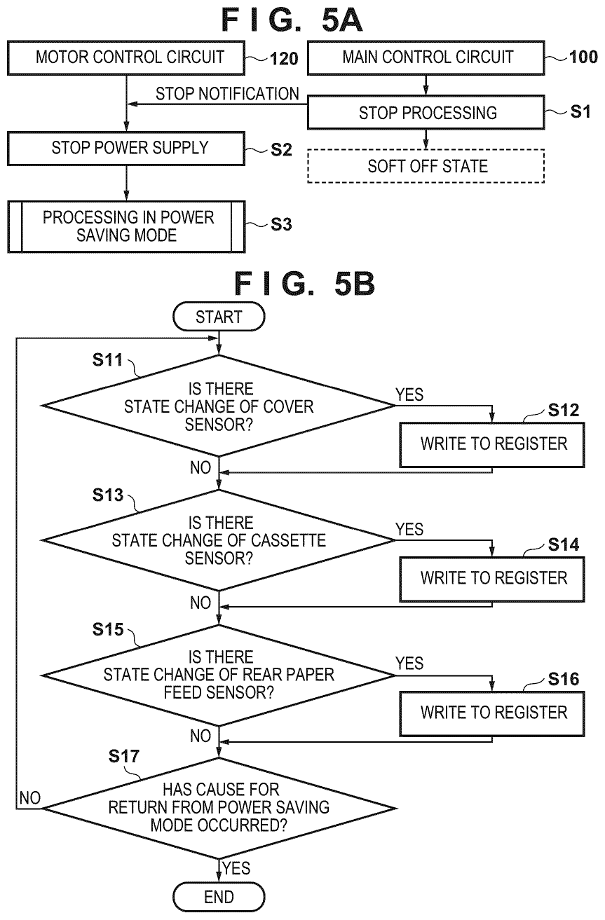

Next, an example of processing to be executed by the control unit 11 will be described with reference to FIG. 5A. FIG. 5A is a flowchart showing each example of processing of the motor control circuit 120 and the main control circuit 100 when shifting from the normal mode to the power saving mode.

In the normal mode, when a specific shift factor occurs, the main control circuit 100 starts stop processing for shifting to the power saving mode (S1). The specific shift factor is, for example, a power off instruction by the user, a case where an idle time has elapsed for a predetermined time, and the like. The stop processing includes transmitting, to the motor control circuit 120, a stop notification indicating that the power mode is shifted to the power saving mode.

In the motor control circuit 120 having received the stop notification, the device control circuit 122 controls the DC/DC control circuit 124 and stops generation of the power source voltages of the DC/DCs 125a and 125b (S2). Power supply to the main control circuit 100 is interrupted, and the electric equipment 1 is brought into the soft off state. The device control circuit 122 executes processing in the power saving mode (S3).

FIG. 5B is a flowchart showing an example of processing in the power saving mode in S3. In the power saving mode, detection results of the cassette sensor, the rear paper feed sensor, and the cover sensor of the sensor group 112 are monitored.

In S11, it is determined whether or not there is a state change of the cover sensor. In a case where the detection result of the cover sensor indicates that opening of the scanner unit 17 is detected, the process proceeds to S12, and a change in the state of the cover sensor (information indicating that the scanner unit 17 is opened) is recorded in the register 123.

In S13, it is determined whether or not there is a state change of the cassette sensor. In a case where the detection result of the cassette sensor indicates that opening of the paper feed cassette 41 is detected, the process proceeds to S14, and a change in the state of the cassette sensor (information indicating that the paper feed cassette 41 is opened) is recorded in the register 123.

In S15, it is determined whether or not there is a state change of the rear paper feed sensor. In a case where the detection result of the rear paper feed sensor indicates that the print medium is set (stacked), the process proceeds to S16, and a change in the state of the rear paper feed sensor (information indicating that the print medium is set) is recorded in the register 123.

Note that here, for simplification of the description, a flow of sequentially performing the processing of the sensor has been described, but the processing of the cover sensor, the cassette sensor, and the rear paper feed sensor can be performed in parallel. That is, when a state transition of any of the sensors occurs, the sensor control circuit 127 of the motor control circuit 120 detects the state transition and records a specific value in the register 123.

In S17, it is determined whether or not a cause for return from the power saving mode to the normal mode has occurred. When the return cause occurs, the processing in the power saving mode ends, and when the return cause does not occur, the process returns to S11 and the similar processing is repeated. The return cause can include a power on operation by the user. For the power on operation, for example, the sensor group 112 includes a sensor that detects the power on operation, and the device control circuit 122 may monitor a state change of the sensor.

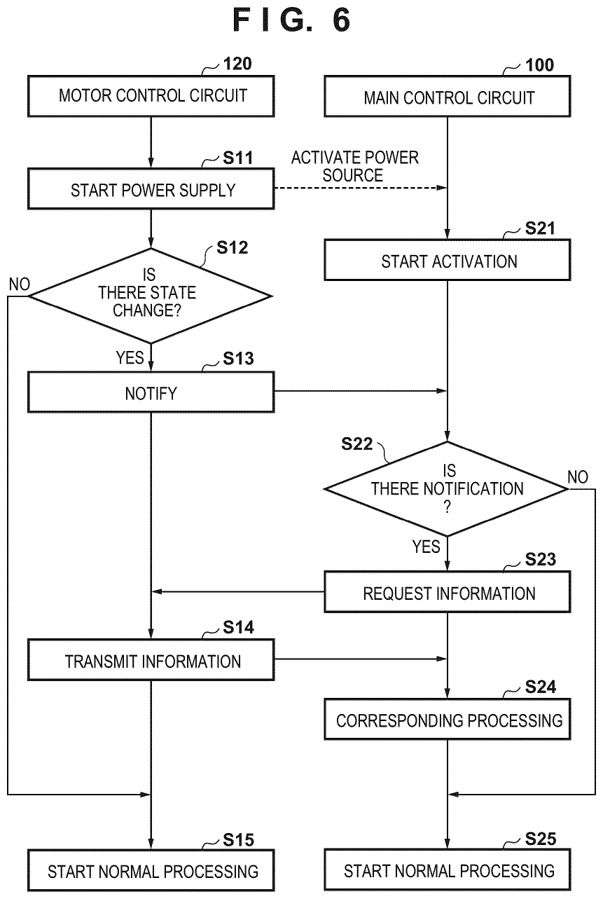

Due to the occurrence of the return cause, the power mode shifts from the power saving mode to the normal mode. FIG. 6 is a flowchart showing an example of processing at the time of shift.

In S11, the device control circuit 122 of the motor control circuit 120 controls the DC/DC control circuit to start generation of the power source voltage by the DC/DCs 125a and 125b. The main control circuit 100 is powered on, and the main control circuit 100 starts activation (S21).

In S12, the device control circuit 122 of the motor control circuit 120 determines whether or not a state change of the sensor is recorded in the register 123. In a case where there is no record of a state change, the process proceeds to S15, and the normal processing (processing in the normal mode) is started. In a case where there is a record of the state change, the process proceeds to S13. In S13, the device control circuit 122 transmits a notification as an interrupt request to the main control circuit 100 via the interface circuit 121.

In S22, the main control circuit 100 determines whether or not there is a notification from the motor control circuit 120. In a case where there is no notification, the process proceeds to S25, and the normal processing (processing in the normal mode) is started. In a case where there is a notification, detection information indicating the detection content of the sensor that has changed during the power saving mode is requested to the motor control circuit 120 (S23). Upon receiving this request, the device control circuit 122 of the motor control circuit 120 reads information from the register 123 to generate detection information, and transmits the detection information to the main control circuit 100 via the interface circuit 121 (S14).

The main control circuit 100 executes corresponding processing based on the received detection information. For example, in a case where opening of the cassette sensor is detected, the user is notified that the print medium has been replaced during the power saving mode, and the setting of the type of the print medium or the like is prompted. In a case where opening of the cover sensor is detected, a notification for confirming to the user whether or not the ink has been replenished is provided. In a case where set of the print medium to the rear tray 42 is detected, a notification for prompting the setting of the type of the print medium or the like is provided.

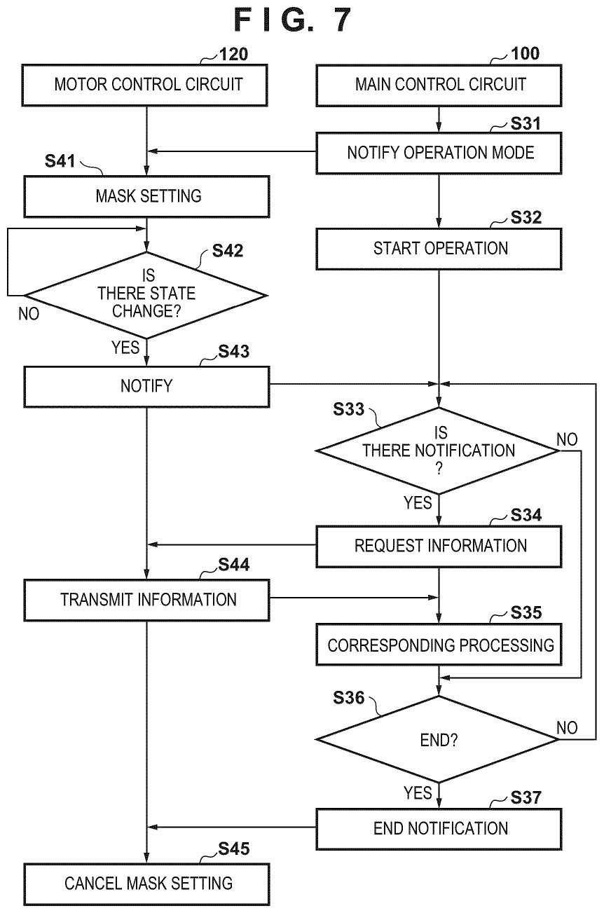

Next, an example of processing of the control unit 11 based on the detection result of the sensor group 112 in the normal mode will be described with reference to the flowchart of FIG. 7. In the case of the present embodiment, as described above, it is possible to control which sensor in the sensor group 112 to monitor in accordance with the operation mode of the electric equipment 1. FIG. 7 illustrates an example of processing thereof.

When a new operation mode is set, the main control circuit 100 notifies the motor control circuit 120 of the operation mode (S31). Upon receiving the notification of the operation mode, the device control circuit 122 of the motor control circuit 120 sets the internal setting to the received operation mode, and performs mask setting for selecting a sensor to be enabled for the sensor control circuit 127 (S41).

For example, during the recovery operation, even if the states of the cassette sensor and the rear paper feed sensor change, the recovery operation is not affected. Therefore, when the recovery operation mode is set, the detection results of the cassette sensor and the rear paper feed sensor are masked, and even if these detection results change, the main control circuit 100 is not notified. This can reduce the frequency of communication between the main control circuit 100 and the motor control circuit 120. On the other hand, during the printing operation, in a case where the states of the cover sensor, the cassette sensor, and the rear paper feed sensor change, the printing operation is affected. Therefore, when the printing operation mode is set, the detection results of the cover sensor, the cassette sensor, and the rear paper feed sensor are not masked, and the main control circuit 100 is notified if these detection results change.

In S32, the main control circuit 100 starts an operation corresponding to the operation mode. For example, in a case where the recovery operation mode is set, the recovery operation is started. In S42, the device control circuit of the motor control circuit 120 determines whether or not there is a state change for a valid sensor in the sensor group 112. When there is a change in the detection result for the valid sensor, the process proceeds to S43.

In S43, the device control circuit 122 of the motor control circuit 120 transmits a notification as an interrupt request to the main control circuit 100 via the interface circuit 121. In S33, the main control circuit 100 determines whether or not there is a notification from the motor control circuit 120. In a case where there is no notification, the process proceeds to S36. In a case where there is a notification, detection information indicating the detection content of the sensor is requested to the motor control circuit 120 (S34). Upon receiving this request, the device control circuit 122 of the motor control circuit 120 generates detection information indicating detection content, and transmits the detection information to the main control circuit 100 via the interface circuit 121 (S44). The main control circuit 100 executes corresponding processing based on the received detection information (S35). The main control circuit 100 determines, for example, whether or not to stop the operation currently being executed based on the received detection information, and ends the operation in a case of determining that stopping it is necessary. In a case of determining that ending the operation is not necessary, the main control circuit 100 temporarily stops the operation until the operation can be resumed, and in a case where the operation can be resumed, the main control circuit 100 resumes the operation.

In S36, the main control circuit 100 determines whether or not the operation being executed has ended, and in a case of determining that the operation has ended, the process proceeds to S37. In S37, the main control circuit 100 notifies the motor control circuit 120 of the end of the operation. Upon receiving the notification of the end, the device control circuit 122 of the motor control circuit 120 cancels the mask set in S41 and cancels the setting of the operation mode.

As described above, in the present embodiment, a sensor that needs to be monitored in the power saving mode can be monitored by the motor control circuit 120, and state detection of the electric equipment 1 can be performed while achieving power saving. Also in the normal mode, the sensor group 112 is not monitored by the main control circuit 100 but monitored by the motor control circuit 120, whereby wiring for connecting the main control circuit 100 and the sensor group 112 is unnecessary, and the circuit configuration can be simplified.

In the normal mode, communication for periodically confirming the detection result of the sensor group 112 is not performed between the main control circuit 100 and the motor control circuit 120. If there is a change in the detection result of the sensor, the processing in which the motor control circuit 120 notifies the main control circuit 100 of the change, whereby the frequency of communication can be reduced. In addition, individual wiring for each sensor is unnecessary between the motor control circuit 120 and the main control circuit 100, and the circuit configuration can be simplified.

Therefore, in each power mode, the state of the electric equipment 1 can be detected with a relatively simple configuration and processing.

Furthermore, the frequency of communication between the motor control circuit 120 and the main control circuit 100 can be further reduced by performing mask setting as to whether or not to enable the interrupt request by a change in the detection result of which sensor in accordance with the operation mode.

### Other Embodiment

In the above embodiment, the notification (S13, S43) from the motor control circuit 120 to the main control circuit 100 regarding the change in the detection result of the sensor and the detection information (S14, S44) are separately transmitted, but the notification may include information corresponding to the detection information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-220997, filed Dec. 17, 2024, which is hereby incorporated by reference herein in its entirety.

What is claimed is:

1. An electric equipment comprising:
a first control unit configured to control the electric equipment;
a second control unit configured to control a power mode of the first control unit; and
at least one detection unit configured to detect a state of the electric equipment, wherein
the power mode of the first control unit includes a first power mode and a second power mode lower in power consumption than the first power mode, and
the second control unit is configured to monitor a detection result of the detection unit in the first power mode and the second power mode, and provide a notification to the first control unit in a case where the detection result of the detection unit changes.

2. The electric equipment according to claim 1, wherein
the second control unit is configured to provide the notification after controlling the power mode of the first control unit from the second power mode to the first power mode in a case where the detection result of the detection unit changes in the second power mode.

3. The electric equipment according to claim 1, comprising
a plurality of detection units, as the at least one detection unit, for different detection targets, wherein
the first control unit is configured to acquire, from the second control unit, information indicating detection content in which a detection result is changed in a case of receiving the notification from the second control unit.

4. The electric equipment according to claim 3, wherein
in the first power mode, the second control unit is configured to:
provide the notification regarding a first detection unit of the plurality of detection units in a first case; and
not provide the notification regarding the first detection unit in a second case.

5. The electric equipment according to claim 4, wherein
the first case is a case where the first control unit is in a first operation mode, and
the second case is a case where the second control unit is in a second operation mode.

6. The electric equipment according to claim 3, wherein
the second control unit is configured to provide the notification in a case where a detection result of any one of the plurality of detection units changes in the second power mode.

7. The electric equipment according to claim 1, wherein
the notification is an interrupt request.

8. The electric equipment according to claim 1, wherein
the second control unit is configured to control an actuator of the electric equipment.

9. The electric equipment according to claim 1, wherein
in the second power mode, supply of power to the first control unit is interrupted.

10. The electric equipment according to claim 1, wherein
the electric equipment is a printing apparatus that discharges liquid onto a print medium to perform printing.

11. The electric equipment according to claim 10, wherein
the printing apparatus includes an opening/closing unit, and
the detection unit is configured to detect opening/closing of the opening/closing unit.

12. The electric equipment according to claim 10, wherein
the detection unit is configured to detect whether or not the print medium is set.
